(19) United States
(12) Patent Application Publication
(10) Pub. No.: US 2008/0142709 A1
(43) Pub. Date: Jun. 19, 2008

(54) MONOLITHIC ta-C NANOPROBES AND ta-C COATED NANOPROBES

(76) Inventors: Anirudha Vishwanath Sumant, Downers Grove, IL (US); Robert William Carpick, Philadelphia, PA (US)

Correspondence Address: FOLEY & LARDNER LLP, 150 EAST GILMAN STREET, P.O. BOX 1497, MADISON, WI, 53701-1497, US

(21) Appl. No.: 11/687,996

(22) Filed: Mar. 19, 2007

Related U.S. Application Data
(60) Provisional application No. 60/784,180, filed on Mar. 21, 2006.

(51) Int. Cl. G01N 23/00

(52) U.S. Cl. 250/306

(57) ABSTRACT

Monolithic tetrahedra amorphous carbon (ta-C) nanoprobes and ta-C coated nanoprobes and methods for fabricating such nanoprobes are provided. The nanoprobes provide hard, wear-resistant, low friction, and chemically inert probes for use in such applications as atomic force microscopy, nanolithography and metrology.

### CROSS-REFERENCE TO RELATED APPLICATION

This application claims the benefit of provisional patent application No. 60/784,180, filed Mar. 21, 2006, the disclosure of which is incorporated herein by reference.

### STATEMENT OF GOVERNMENT RIGHTS

Research ending was provided for this invention by the Department of Energy under grant number DE-FG02-02ER46016. The United States government has certain rights in this invention.

### FIELD OF THE INVENTION

This invention relates to fabrication of monolithic nanoprobes composed of, or coated with, tetrahedral amorphous carbon for use in applications such as scanning probe microscopy and nanolithography.

### BACKGROUND

Hard, wear resistant, nano-scale probe tips are required for scanning probe microscopy (SPM) in a number of applications such as imaging, metrology, nanomachining, nano-manufacturing, nano-scale data storage, nanotribology measurements and nanomechanics experiment Ultrahard carbon-based films, such as diamond, are excellent candidate materials for such applications. However, either coating an existing silicon probe tip with diamond or fabricating a monolithic cantilever with a well-defined, nano-scale tip is an extremely difficult task. This is because conventional growth methods produce diamond with large grain sizes (1-5 μm). Indeed, diamond-coated tips are available commercially, but they show poor performance, including poorly-defined, large, and rough tip shapes, and fracture of the microcrystalline grains during use. Thus, a need exists for a fracture and wear resistant nano-scale probe tip.

### SUMMARY OF THE INVENTION

Monolithic tetrahedral amorphous carbon (ta-C) nanoprobes and ta-C coated nanoprobes and methods for fabricating such nanoprobes are provided. The nanoprobes provide hard, wear-resistant, low friction, and chemically inert probes for use in such applications as atomic force microscopy and nanolithography.

The nanoprobes include a cantilever arm and a nanoprobe tip extending outwardly from the cantilever arm. The nanoprobe tip may be integrated with the cantilever arm. The cantilever arm and nanoprobe tip of the monolithic nanoprobes are constructed from ta-C. The cantilever arm and nanoprobe tip of the ta-C coated nanoprobes are constructed from a material other than ta-C, but have a ta-C film coating at least a portion of the nanoprobe tip. In some embodiments of the ta-C coated nanoprobes, the entire nanoprobe tip is coated by a ta-C film. ta-C films having thicknesses of no greater than 10 nm may be formed on the nanoprobe tips. Monolithic ta-C nanoprobe tips and ta-C coated nanoprobe tips having tip radii of no more than about 20 nm may be fabricated by the methods disclosed herein. The ta-C used to make the nanoprobes is desirably, but not necessarily, stress-relieved ta-C.

The monolithic nanoprobes may be fabricated by forming a film of ta-C on the surface of a sacrificial substrate that defines one or more nanoprobe tip pits. The ta-C fills the one or more tip pits which act as a mold for the nanoprobe tips. The tip pits are typically pyramidal is shape, but may take on other geometries provided they terminate in a specifically narrow point. Lithography may then be used to form one or more cantilever arms from the ta-C on the surface of the sacrificial substrate surrounding the one or more tip pits. Finally, the sacrificial substrate may be removed (e.g., by etching) to release the monolithic ta-C nanoprobes.

The ta-C coated nanoprobes may be fabricated by coating at least a portion of a nanoprobe tip with a thin film of ta-C. The nanoprobes that form the substrate onto which the ta-C is coated may comprise, for example, silicon, silicon nitride or piezoelectric materials.

The ta-C films used to make the monolithic ta-C nanoprobes and the ta-C coated nanoprobes may be deposited using chemical vapor deposition (CVD) or pulsed laser deposition (PLD).

Further objects, features and advantages of the invention will be apparent from the following detailed description when taken in conjunction with the accompanying drawings.

### BRIEF DESCRIPTION OF THE DRAWINGS

FIG. 1 is a schematic diagram showing the steps in a process for fabricating a monolithic ta-C nanoprobe.

### DETAILED DESCRIPTION OF THE INVENTION

The present invention provides monolithic ta-C and ta-C coated nanoprobes. For the purposes of this disclosure, ta-C is a form of tetrahedral amorphous carbon having at least about 60% sp³-bonded carbon, no more than about 40% sp²-bonded carbon, and no more than about 10% hydrogen. The ta-C used to make the nanoprobes desirably contains at least about 80% sp³-bonded carbon and no more than about 5% hydrogen. ta-C differs from crystalline diamond, polycrystalline diamond, nanocrystalline diamond and ultrananocrystalline diamond in that ta-C has no long range order and is amorphous in nature as opposed to the well defined crystalline nature of other types of diamond films, and produces only diffuse reflections in electron or x-ray scattering measurements. A phase diagram for various forms of carbon may be found in J. Robertson, Amoorphous Carbon: State of the Art, World Scientific, Singapore, 1998, p. 32. This phase diagram that clearly shows the composition of ta-C in terms of sp³-bonded carbon, sp²-bonded carbon and hydrogen. This phase diagram also clearly distinguishes ta-C from other forms of carbon, including glassy carbon, amorphous carbon (a-C), diamond, ultrananocrystalline diamond (UNCD), and higher hydrogen-content diamond like coatings (DLCs), such as ta-C:H and a-C:H.

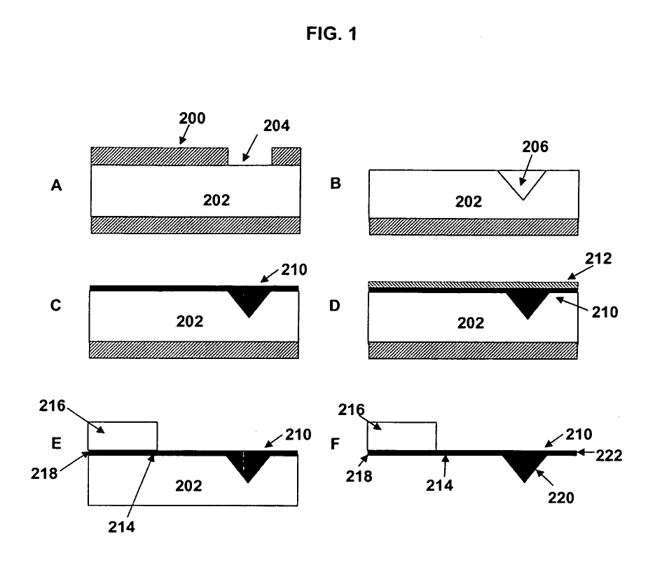

A first aspect of the invention provides monolithic nanoprobes fabricated from ta-C. The nanoprobes include a cantilever arm having a proximal end and a distal end and a nanoprobe tip disposed at or near the distal end of the cantilever arm and extending outwardly therefrom. FIG. 1 is a schematic diagram showing a method for making a monolithic ta-C nanoprobe. The method is adapted from a method of making S₃N₄ probes available commercially. Fabrication begins by forming one or more nanoprobe tip pits an a sacrificial substrate. This may be accomplished by forming a mask 200 (e.g., a SiN mask) over a sacrificial substrate 202 and lithographically patterning the oxide layer with one or more, typically square, openings 204 (step A), followed by etching (e.g., with KOH (30%, 80° C.)) one or more, typically pyramidal, nanoprobe tip pits 206 in the sacrificial substrate (step B). In some embodiments, the sacrificial substrate may be a Si(100) wafer. An array composed of a plurality of nanoprobe tip pits may be formed in the sacrificial substrate in order to allow for the simultaneous fabrication of large numbers of nanoprobes on a single substrate, Optionally, the nanoprobe tip pits may be subjected to a thermal oxidation sharpening process at high temperature (e.g., 900° C.) to produce a thin (e.g., >1 nm) oxide layer on the surface of the sacrificial substrate (not shown). A layer of ta-C 210 is then deposited over the one or more nanoprobe tip pits (step C). This deposition may be carried out using a pulsed laser deposition process as described in U.S. Pat. No. 6,103,305, the entire disclosure of which is incorporated by reference. A metal layer 212 (e.g., Al (80 nm)) may then be deposited over the ta-C by electron-beam evaporation and patterned with a mask (not shown), followed by a metal etch to define the cantilever arms 214. The pattern of cantilever arms may be transferred into the ta-C using a reactive ion etching (RIE) (step D), after which the metal layer is removed (e.g., by wet chemical etching) (step E). A handle 216 may then be physically bonded to the proximal end 218 of each cantilever (step E). Sacrificial substrate 202 is then removed (e.g., by a chemical etch) to release the one or more monolithic nanoprobes, each having an integrated nanoprobe tip 220 disposed at or near the distal end 222 of its cantilever arm. Using this process, nanoprobes with nanoprobe tip radii of less than or equal to about 30 nm may be produced. This includes nanoprobes with tip radii of no more than about 20 nm, no more than about 15 nm, and even no more than about 10 nm.

A second aspect of the invention provides ta-C coated nanoprobes. The ta-C coated nanoprobes are fabricated by depositing a thin ta-C film on a pre-fabricated nanoprobe tip made from a material other than ta-C. Typical materials for the pre-fabricated nanoprobe tip include silicon, silicon nitride and piezoelectric materials. In some embodiments, the ta-C coating may have a thickness of no greater than about 10 nm. This includes embodiments where the ta-C coating has a thickness of no greater than about 5 nm n, or even not greater than about 3 nm. Depending on the initial radius of the pre-fabricated nanoprobe tips, ta-C coated tips having tip radii of no greater than about 20 nm may be formed. This includes embodiments where the tip radius is no more than about 10 nm. The use of thin ta-C coatings on nanoprobes is advantageous because ta-C has a high electrical resistivity and thermal stability, therefore, may be used as a coating on nanoprobes having integrated electrical components, such as embedded heaters, without the risk of shorting electrical components and connections.

The ta-C used to fabricate the monolithic and ta-C coated nanoprobes may be produced using PLD in accordance with the method described in U.S. Pat. No. 6,103,305. Briefly, this method involves the deposition of ta-C in vacuum on a substrate (e.g., silicon) using conventional PLD with a rotating solid carbon (e.g., graphite) target and a KrF (248 nm) laser. The resulting ta-C layers are formed under compressive stress. However, a low temperature anneal may be used to relieve this stress as described in U.S. Pat. No. 6,103,305. The amount of stress in the ta-C may be controlled depending upon the temperature and duration of annealing. This is advantageous because the desired level of stress may be different for different applications. For example, a higher degree of compressive stress may be desirable for nanoprobes designed for use in applications where wear resistance is important, such as contact atomic force microscopy, because a higher level of compressive stress makes the material resistant to fractures caused by tensile stress.

The nanoprobe tips may be used in a variety of applications, but are particularly useful in applications where wear-resistance is important. One such application is contact atomic force microscopy. Another such application is nanolithography, particularly dip-pen or fountain pen lithography as well as metrology. Other suitable applications include, but are not limited to, scanning spreading resistance microscopy, atomic-scale potentiometry and scanning thermal microscopy.

A high capacity storage system which uses an array of nanoprobe tips to read and write bits on a thin polymer film is an example of a suitable use for the present nanoprobes. Such a system is the subject of IBM's Millipede Project. In such systems, a dense, two dimensional array of 1000 or more nanoprobes are used to punch holes in a thin polymer film, typically coating a thin silicon substrate. The nanoprobes for use in this application desirably include a heating element coupled to, or integrated with, the nanoprobe. By heating the nanoprobe tips, the polymer film may be softened, allowing the tips to penetrate its surface, creating indentations (or bits) in the film. The nanoprobes for use in these systems desirably have cantilever arms with cross-sectional diameters of no more than about 1 μm, desirably no more than about 0.5 μm and lengths of no more than about 100 μm, desirably no more than about 75 μm.

Functionalized nanoprobes may also be used to detect chemical or biochemical species on a surface, or to measure chemical or biochemical interactions between functional groups on a nanoprobe tip and functional groups on a surface over which the nanoprobes are scanned. For example, a nanoprobe tip may be functionalized with a biomolecule which interacts with (e.g., hybridizes with) another biomolecule of interest. When the functionalized nanoprobe is scanned over a surface having (or suspected of having) the biomolecule of interest associated with it, interactions between the two biomolecules may be detected or measured (e.g., by detecting a deflection in the cantilever arm). Biomolecules for use in the functionalization of (and the detection by) the nanoprobes of the present invention are well-known in the art. Suitable biomolecules include, but are not limited to, biomolecules independently selected from the group consisting of oligonucleotide sequences, including both DNA and RNA sequences, amino acid sequences, proteins, protein fragments, ligands, receptors, receptor fragments, antibodies, antibody fragments, antigens, antigen fragments, enzymes and enzyme fragments. Thus, the biomolecular interactions that may be studied include, but are not limited to, receptor-ligand interactions (including protein-ligand interactions), hybridization between complementary oligonucleotide sequences (e.g. DNA-DNA interactions or DNA-RNA interactions), and antibody-antigen interactions. The monolithic ta-C nanoprobes and the ta-C coated nanoprobes may be functionalized according to the methods disclosed in U.S. Patent Application Publication No. 2005/0214535, the entire disclosure of which is incorporated herein by reference.

For the purposes of this disclosure and unless otherwise specified, “a” or “air” means “cone or more”. All patents, applications, references and publications cited herein are incorporated by reference in their entirety to the same extent as if they were individually incorporated by reference.

While the principles of this invention have been described in connection with specific embodiments, it should be understood clearly that these descriptions are made only by way of example and are not intended to limit the scope of the invention.

What is claimed is:

1. A monolithic nanoprobe comprising a cantilever arm and a nanoprobe tip extending outwardly from the cantilever arm, wherein the cantilever arm and the nanoprobe tip comprise ta-C.

2. The nanoprobe of claim 1, wherein the ta-C is stress relieved ta-C.

3. The nanoprobe of claim 1, wherein the nanoprobe tip is functionalized with chemical or biochemical functionalities.

4. The nanoprobe of claim 1, wherein the nanoprobe tip radius is no greater than 10 nm.

5. An array of nanoprobes comprising a plurality of the nanoprobes of claim 1 arranged in an array.

6. A coated nanoprobe comprising a cantilever arm, a nanoprobe tip extending outwardly from the cantilever arm, and a ta-C film coating at least a portion of the nanoprobe tip.

7. The nanoprobe of claim 6, wherein the ta-C film has a thickness of no more than about 10 nm.

8. The nanoprobe of claim 6, wherein the ta-C film has a thickness of no more than about 5 nm.

9. The nanoprobe of claim 6, wherein the ta-C film coating at least a portion of the nanoprobe tip is functionalized with chemical or biochemical functionalities.

10. The nanoprobe of claim 6, wherein the nanoprobe further comprises an embedded heating element.

11. The nanoprobe of claim 6, wherein the cantilever arm and the nanoprobe tip comprise a piezoresistive material.

12. The nanoprobe of claim 6, wherein the cantilever arm and the nanoprobe tip comprise silicon.

13. An array of nanoprobes comprising a plurality of the nanoprobes of claim 6 arranged in an array.

14. A method of fabricating a monolithic nanoprobe, the method comprising:
(a) forming a pit in a surface of a sacrificial substrate;
(b) depositing ta-C over the pit and at least a portion of the surrounding surface of the sacrificial substrate, whereby the ta-C in the pit forms a nanoprobe tip;
(c) forming a cantilever arm from the ta-C deposited over the surrounding surface of the sacrificial substrate; and
(d) releasing the cantilever arm and the nanoprobe tip from the sacrificial substrate.

15. The method of claim 14, further comprising affixing a handle to the cantilever arm.

16. The method of claim 14, further comprising annealing the deposited ta-C to provide stress-relieved ta-C.

17. A method of fabricating a coated nanoprobe comprising a cantilever arm and a nanoprobe tip, the method comprising coating at least a portion of the nanoprobe tip with a film of ta-C.

18. The method of claim 17, wherein the ta-C film has a thickness of no more than about 10 nm.

19. The method of claim 17, wherein the ta-C film has a thickness of no more than about 5 nm.

20. The method of claim 17, wherein the cantilever arm and the nanoprobe tip comprise a piezoresistive material.

21. The method of claim 17, wherein the cantilever arm and the nanoprobe tip comprise silicon.
